(19) United States
(12) Patent Application Publication
(10) Pub. No.: US 2008/0162944 A1
(43) Pub. Date: Jul. 3, 2008

(54) INFORMATION PROCESSING APPARATUS, INFORMATION PROCESSING SYSTEM, AND COMPUTER READABLE STORAGE MEDIUM

(75) Inventor: Akira Suzuki, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/753,690

(22) Filed: May 25, 2007

(30) Foreign Application Priority Data
Dec. 28, 2006 (JP) 2006-356030

(51) Int. Cl. H04K 1/00

(52) U.S. Cl. 713/185

(57) ABSTRACT

There is provided a information processing apparatus, including a receiving unit that receives a derivation information item; a derivation relationship storage that stores the derivation information item; a registration unit that registers the child identification information included in the derivation information item in an isolated information storage, if no derivation information items including, as a child, the parent identification information included in the derivation information are stored in the derivation relationship storage, or if the parent identification information included in the derivation information is stored in the isolated information storage; and a processing executing unit that traverses a tree represented by derivation information items and executes processing with reference to a result of the traversal, the executing unit transmitting a notification indicating that there is a possibility that a correct processing result is not obtained when the identification information included in the instruction is stored in the isolated information storage.

### CROSS-REFERENCE TO RELATED APPLICATIONS

This application is based on and claims priority under 35 USC 119 from Japanese Patent Application No. 2006-356030, filed on Dec. 28, 2006.

### BACKGROUND

1. Technical Field

The present invention relates to an information processing apparatus, an information processing system, and a computer readable storage medium.

2. Related Art

There has been technology for registering an electronic document such as text document data, audio data, multimedia data, and so on (hereinafter also referred to simply as a document) in a server and providing the document in response to a user request. Also, a system has been known in which a unique identifier is assigned to an electronic document and an electronic document corresponding to the identifier input by a user is provided. In another known system, when printing an electronic document onto a paper sheet, an identifier of the electronic document is encoded and embedded into the paper document, and then for copying the paper document, the identifier embedded therein is recognized to obtain the electronic document corresponding to the identifier, and then the electronic document is printed on paper.

### SUMMARY

According to one aspect of the invention, there is provided a second information processing apparatus, including a receiving unit that receives, from a first information processing apparatus, a derivation relationship information item including identification information of a document prior to an operation as a parent, and identification information after the operation as a child; a derivation relationship storage unit that stores the derivation relationship information item that is received; a first registration unit that, when receiving the derivation relationship information item from the first information processing apparatus, registers the child identification information included in the derivation relationship information item that is received in an isolated information storage unit, if no derivation relationship information item including, as a child, the parent identification information included in the derivation relationship information that is received are stored in the derivation relationship storage unit; a second registration unit that, when receiving the derivation relationship information item from the first information processing apparatus, registers the child identification information included in the derivation relationship information item that is received in the isolated information storage unit, if the parent identification information included in the derivation relationship information item that is received is stored in the isolated information storage unit; and a processing executing unit that, when receiving a processing instruction including identification information, traverses a tree structure of identification information represented by derivation relationship information items stored in the derivation relationship storage unit using the identification information included in the processing instruction as a start point, and executes processing with regard to the processing instruction with reference to a result of the traversal, the processing executing unit transmitting a notification indicating that there is a possibility that a correct processing result cannot be obtained to a source that has issued the processing instruction when the identification information included in the processing instruction is stored in the isolated information storage unit.

### BRIEF DESCRIPTION OF THE DRAWINGS

Exemplary embodiments of the present invention will be described in detail based on the following figures, wherein:

FIG. 1 is a block diagram schematically showing an example structure of a document use management system;

FIG. 2 is a block diagram showing an example internal structure of a client terminal;

FIG. 3 is a view schematically showing an example data structure of an ID-added document;

FIG. 4 is a block diagram showing an example internal structure of a document management server;

FIG. 5 is a view showing example data content of a derivation relationship DB;

FIG. 6 is a view showing example data indicating correspondence between management IDs and document contents;

FIG. 7 is a view schematically showing the derivation relationship indicated by the data contents illustrated in FIG. 5;

FIG. 8 is a flowchart showing an example processing procedure of a client terminal when an operation is performed with respect to a document;

FIG. 9 is a flowchart showing an example processing procedure of a registration processing unit;

FIG. 10 is a flowchart showing a portion of an example processing procedure of a document registration unit;

FIG. 11 is a flowchart showing the remaining portion of the example processing procedure of the document registration unit;

FIG. 12 is a flowchart showing an example processing procedure of a request processing unit;

FIG. 13 is a flowchart showing an example processing procedure of the request processing unit in a modification example;

FIG. 14 is a flowchart showing an example processing procedure of a derivation relationship search unit in a modification example; and

FIG. 15 is a view showing an example hardware structure of a computer.

### DETAILED DESCRIPTION

An exemplary embodiment of the present invention will be described in detail with reference to the accompanying drawings.

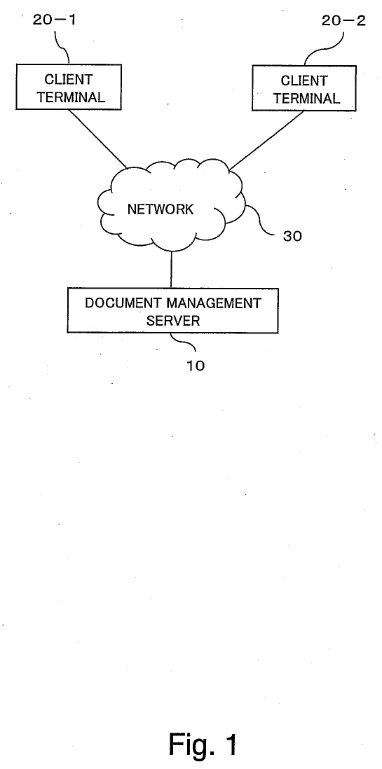

FIG. 1 is a block diagram schematically showing a structure of a document use management system. This system is formed of a document management server 10 and client terminals 20-1, 20-2, . . . (hereinafter collectively referred to as a client terminal 20) that are connected to each other via a network 30 such as the Internet and Local Area Network, and so on.

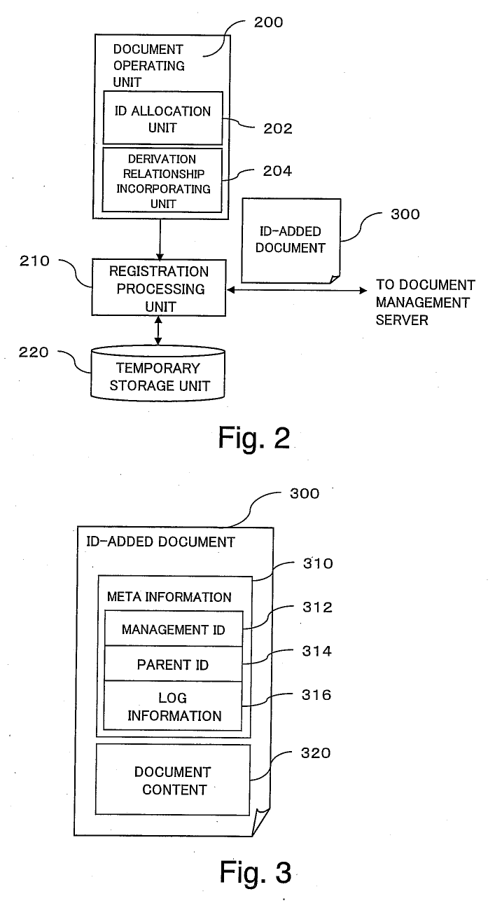

The client terminal 20 will be described with reference to FIG. 2. The client terminal 20 is a terminal used by a user for operating a document, and may be a personal computer, a digital multifunction device, and so on. The client terminal 20 includes a document operating unit 200, a registration processing unit 210, and a temporary storage unit 220. The document operating unit 200 is used for performing an operation with respect to a document, including display (i.e. “viewing” by a user), editing, print and output of a document, reading and copying of a paper document, and so on. While only a single document operating unit 200 is shown in FIG. 2, the individual operations may be performed by different operating units (e.g. different applications such as an editing application and a reading control application). If the document operating unit 200 is software used for creating and editing an electronic document, such as a word processor, for example, the document operating unit 200, in accordance with a user's instruction, displays an electronic document or edits the electronic document. The document operating unit 200, when performing an operation with respect to a document, outputs an ID-added document 300 that represents a result of the operation.

As shown in FIG. 3, the ID-added document 300 is an electronic document including meta information 310 and a document content 320. The document content 320 corresponds to content data of a document that is generated as a result of the operation performed by the document operating unit 200. If the document operating unit 200 is software that creates and edits an electronic document, the document content 320 is a document file generated as a result of editing performed by the software. Alternatively, if the document operating unit 200 is a device that prints an electronic document, the document content 320 may be content data of an electronic document to be printed. Further, if the document operating unit 200 is a device that scans a paper document or a device that copies a paper document, the document content 320 may be image data obtained by reading the paper document.

The meta information 310 is information used for document management, and includes a management ID 312, a parent ID 314, and log information 316.

The management ID 312 is unique identification information of an ID-added document 300 itself. The parent ID 314 is a management ID of a parent ID-added document of that ID-added document 300. Specifically, in this exemplary embodiment, a certain ID-added document and a new ID-added document obtained by performing an operation with respect to the certain ID-added document are treated as being in a parent-child relationship. More specifically, when a second ID-added document is obtained by operating a first ID-added document, the first ID-added document is a parent of the second ID-added document, and the second ID-added document is a child of the first ID-added document. For example, when the document operating unit 200 performs an operation with respect to an ID-added document having a management ID “A” and a new ID-added document having a management ID “B” is obtained as a result of the operation, the management ID 312 in the meta information 310 of the latter document is “B” and the parent ID 314 of this document is “A”. Such a parent-child relationship will be referred to a “derivation relationship (of management IDs)”.

Here, in a case where an operation of initially registering an electronic document which has not been registered in the present system is performed and also in a case where an operation of scanning or copying an unregistered paper document is performed (in the latter case, an ID-added document including an image obtained by reading the paper document as its document content is generated and registered in the present system), the ID-added document 300 which is generated would have no parent ID 314 (that is, no parent exits)

The log information 316 refers to information of various log items concerning the operation performed when the ID-added document is generated. The log items may include the time and date when the operation is performed, the type of the operation, a user (operator) who instructs the operation, and so on, and are not limited to these examples. The operation types include, for example, registration (i.e. registration of a new document in the present system), viewing, update (change of document content), printing, scanning, copy of a paper document, and so on. For example, when a user uses the document operating unit 200 to edit a first ID-added document and then instructs completion of editing, the log information 316 of the resulting second ID-added document includes the time of editing completion, identification information of a user who instructed the editing, and the type of operation “update”.

Referring back to FIG. 2, the document operating unit 200 includes an ID allocation unit 202 and a derivation relationship incorporating unit 204 so as to generate the ID-added document 300 described above as a result of an operation. The ID allocation unit 202 allocates a unique management ID to an ID-added document generated as a result of an operation. The management ID needs to be identification information that is unique at least within the present system. For example, it is possible to obtain a hash value of an ID-added document 300 (excluding the management ID 312) to be generated as a result of an operation and use the hash value as a management ID of the ID-added document 300. When a collision-resistant cryptographic hash function, such as SHA-256 (which is a cryptographic hash function having a hash value of 256 bits defined in FIPS (Federal Information Processing Standards) 180-2 by the NIST (National Institute of Standards and Technology), is used as the hash function, a management ID having practically sufficient uniqueness can be generated. As a matter of course, a method of generating a management ID which is unique within the system by each client terminal 20 is not limited to the above example. When the management ID includes identification information that is specific to each client terminal 20, the management ID that is unique within the system can be generated in each client terminal 20.

The derivation relationship incorporating unit 204 generates meta information 310 including a new management ID 312 allocated to a document obtained by a result of an operation by the ID allocation unit 202, a parent ID 314 which is a management ID of a parent document with regard to which the operation has been performed (in the case of initial registration, no such parent ID exists), and log information 316 concerning the operation. The derivation relationship incorporating unit 204 further adds the meta information 310 to the document content of the operation result to thereby generate and output an ID-added document 300 obtained after the operation.

The registration processing unit 210 performs processing for registering the ID-added document 300 output from the document operating unit 200 to the document management server 10. Thus, each client terminal 20 registers the ID-added document 300 obtained as a result of an operation performed by each client terminal 20 itself to the document management server 10 as described above, so that the document management server 10 can recognize the derivation relationship between each ID-added document 300.

The ID-added document 300 output from the document operating unit 200 as a result of an operation can be sent to others by electronically copying or by attaching to an electronic mail and so on, similar to cases with general document files. When a user who receives an ID-added document 300 from other user uses the document operating unit 200 of his/her own client terminal 20 to operate the received ID-added document 300, a new ID-added document to which a new management ID is assigned in accordance with the operation is to be generated.

Further, when printing an electronic document with the document operating unit 200, the document operating unit 200 may generate a management ID and embed the management ID in the printed electronic document. Here, embedding of the management ID can be performed, for example, by superposing a code image representing the management ID with a printed image of the electronic document. In this case, the document operating unit 200 registers an ID-added document including meta information such as the management ID, the operation type, which is “printing” in this case, and so on, in the document management server 10. Further, when an ID-added document is printed, a new ID-added document including the management ID of the ID-added document as a parent ID 314 is generated. The new ID-added document corresponding to such a printing operation may include, as the document content 320, printing data such as page description language data and bit map image data representing a printed image.

Further, when a paper document having a management ID embedded therein is read by the document operating unit 200, the document operating unit 200 assigns a new management ID with respect to the reading operation, and generates an ID-added document including an image of the reading result as the document content 320 and registers the ID-added document in the document management server 10. The management ID read from the original paper document is set as a parent ID 314 of the ID-added document. At the time of copying a paper document having a management ID embedded therein, both the reading processing and the printing processing described above are to be performed.

Here, when the client terminal 20 cannot access the document management server 10 such as in a case where the network 30 has some problems, where the client terminal 20 and the network 30 are disconnected, or where the document management server 10 has some problems, the registration processing unit 210 cannot register an ID-added document 300 in the document management server 10. When the document operating unit 200 outputs an ID-added document 300 in such cases, the registration processing unit 210 stores the ID-added document 300 in the temporary storage unit 220 and later registers the ID-added document 300 in the document management server 10 when access to the document management server 10 becomes available.

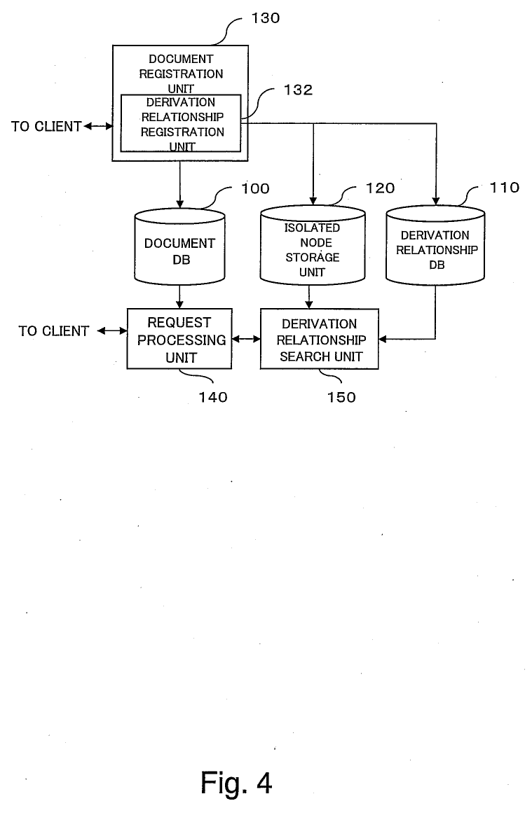

Referring now to FIG. 4, the document management server 10 will be described. The document management server 10 stores ID-added documents 300 sent from a plurality of client terminals 20 in the system and provides various services to users based on the stored information. The document management server 10 includes a document DB 100, a derivation relationship DB 110, an isolated node storage unit 120, a document registration unit 130, a request processing unit 140, and a derivation relationship search unit 150.

The document DB 100 is a database that stores a document content 320 of an ID-added document 300 transmitted from the client terminal 20. Each document content 320 stored in the document DB 100 is managed by using a unique content ID. While a hash value obtained by a cyptographic hash function of the corresponding document content may be used as the content ID, the content ID is not limited to this example. The content ID may be assigned by the client terminal 20, in which case, the content ID may be included in the meta information 310.

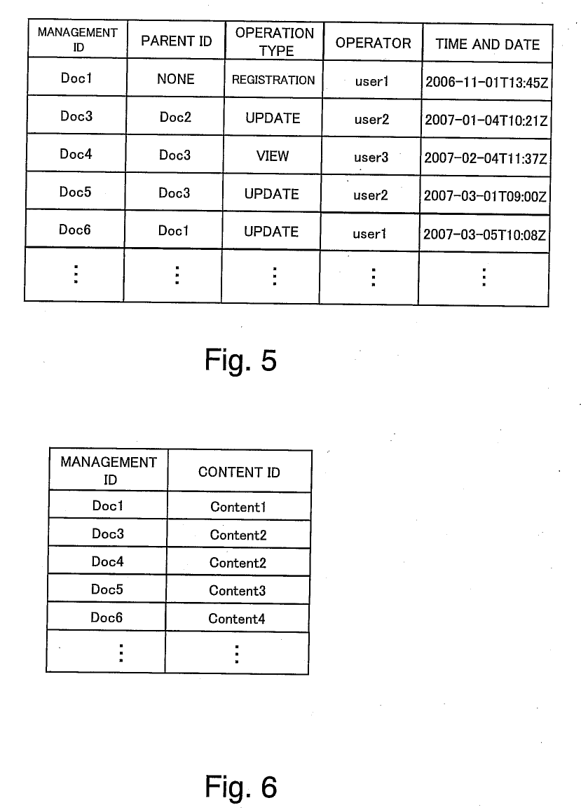

The derivation relationship DB 110 is a database that stores meta information mainly concerning the information of a derivation relationship in such an ID-added document 300. FIG. 5 shows an example data content of the derivation relationship DB 110. The information in one row in the table shown in FIG. 5 represents a meta information record corresponding to one ID-added document 300. In this example, items including a parent ID, an operation type, an operator, and an operation time and date, are registered corresponding to the management ID of each ID-added document 300. The information items in the meta information record are not limited to the above example, and any items necessary for the purpose of management can be recorded, as long as the pair of the management ID and the parent ID is included.

Here, FIG. 5 merely expresses the data managed by the derivation relationship DB 110 from a viewpoint of data content, and does not therefore specify any specific expression form or database form. For example, the derivation relationship DB 110 may be configured as a general relational database, or a database in which a XML (extensible Markup Language) document that describes meta information other than the management ID is registered using the management ID as a key.

Further, the correspondence between the document content registered in the document DB 100 and the meta information registered in the derivation relationship DB 110 is managed by the correspondence information as shown in FIG. 6. Such correspondence information is obtained by recording the content ID of a document content in association with the management ID. This correspondence information may be held by the document DB 100 or by the derivation relationship DB 110.

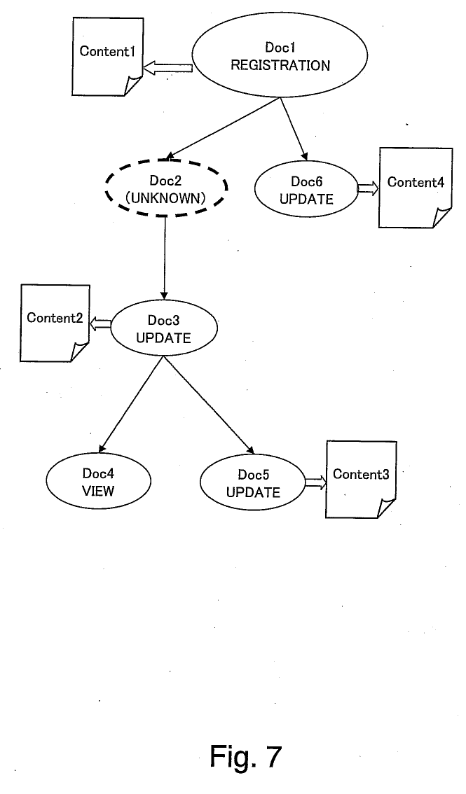

The data content of the derivation relationship DB 110 shown in FIG. 5 forms a tree structure as shown in FIG. 7, in which the management IDs are nodes and the parent-child relationships among the management IDs are edges.

The log of the documents shown in the example of FIGS. 5 to 7 will be described below in time sequence. First, a “registration” operation of a document which has not been registered in the document management server 10 is performed by the client terminal 20 of a user 1. In response to this operation, an ID-added document “Doc1” including meta information having a management ID “Doc1”, no parent ID, and an operation type “registration”, and a document content of the ID-added document, are transmitted from the client terminal of the user 1 to the document management server 10. In response, the document management server 10 registers the document content of the ID-added document “Doc1” in the document DB 100 and registers the meta information of the document “Doc1” in the derivation relationship DB 110. The document content thus registered is to be managed in association with a content ID “Content 1”. The ID-added document “Doc1” is then operated on by any client terminal, and as a result of this operation, an ID-added document “Doc2” is generated. At this point in time, however, because the client terminal that performed the operation cannot access the document management server 10, the ID-added document “Doc2” is not transmitted to the document management server 10. Subsequently, a user 2 operates the ID-added document “Doc2” on their client terminal, and registers an ID-added document “Doc3” obtained as a result of the operation in the document management server 10. Because the document management server 10 has not received the ID-added document “Doc2” at this point in time, the document management server 10 merely recognizes that the ID-added document “Doc3” is an update result of an unknown document “Doc2” and cannot grasp the fact that an ancestor of the ID-added document “Doc3” is the ID-added document “Doc1”. Then, a user 3 views the document “Doc3” and registers a resulting document “Doc4” in the document management server 10. Here, the document content of the document “Doc4” is the same as that of the document “Doc3”. Further, in accordance with an editing operation (“update”) of the document “Doc3” by the user 2, a document “Doc5” obtained as a result of this editing operation is registered in the document management server 10. Further, the document “Doc1” is then edited, and a document “Doc6” obtained as a result of the editing is registered in the document management server 10.

The isolated node storage unit 120 is a storage device that stores a node (i.e. a management ID) that cannot reach the root in the tree structure of the derivation relationship. Processing using the isolated node storage unit 120 will be described in detail below.

The document registration unit 130 registers the document content and the meta information of an ID-added document received from the client terminal 20 in the document DB 100 and the derivation relationship DB 110, respectively. Of these registration operations, registration of the meta information is performed by the derivation relationship registration unit 132.

The request processing unit 140 provides a service by using the derivation relationship DB 110, in response to a service request including the management ID transmitted from the client terminal 20. A service to be provided by the request processing unit 140 may include search of the latest version of a document corresponding to the management ID for which the service is being requested. Another example service may be a service of providing an ancestor document corresponding to the management ID for which the service is being requested or the log information of the ancestor, or a service of providing the history of the management ID, that is an operation history of the documents from the ancestor up to the management ID (i.e. an information list indicating who performs what kind of operation, and so on).

The service request is issued based on an ID-added document held by the client terminal 20. For example, when a user operates the document operating unit 200 of the client terminal 20 to open an ID-added document, the document operating unit 200 provides a service menu using the derivation relationship, receives user's designation of a desired service among the menu, and transmits a service request including the document ID of the ID-added document and a code indicating the designated service to the request processing unit 140 of the document management server 10.

Alternatively, it is also conceivable to regard a user's designation of a service as one “operation” and assign a new management ID to the “operation”. In this case, it is possible to generate an ID-added document including a code of the designated service as an operation type and the management ID of the original ID-added document that was used at the time of designation of a service as a parent ID, and transmit this ID-added document to the document management server 10 as a service request. In this case, the request processing unit 140 determines a service to be provided based on the information of an operation type in the ID-added document that is received and uses the parent ID of that ID-added document as a start point when tracing back the derivation relationship.

The request processing unit 140, when receiving a service request from the client terminal 20, transmits a search request including the management ID that is designated at the time of service request as at least one item of the search conditions to the derivation relationship search unit 150.

The derivation relationship search unit 150, in accordance with a search request from the request processing unit 140, traverses a tree configured by the derivation relationship between the management IDs and the parent IDs registered in the derivation relationship DB 110, and returns the information obtained as a result of the traversal to the request processing unit 140. The request processing unit 140 then uses the information concerning the traversal result to perform the service requested by the user.

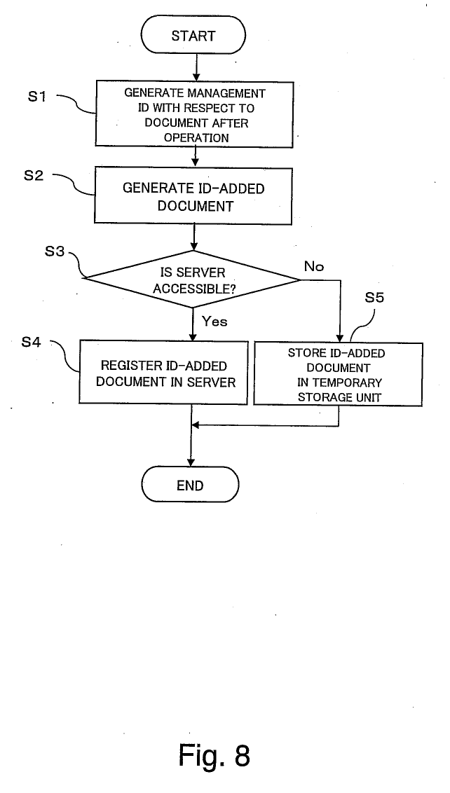

The content of processing to be performed by the system of the present exemplary embodiment will be described in detail. Referring first to FIG. 8, an example processing procedure of the client terminal 20 when an operation is performed with respect to a document will be described. When an operation is performed with respect to a document, the document operating unit 200 generates a management ID with respect to a document obtained as a result of the operation (S1). The document operating unit 200 then obtains various information concerning the operation from an operating system and other systems to generate meta information, and generates an ID-added document including the meta information and the document content obtained after the operation, and further provides the ID-added document to the registration processing unit 210 (S2). The registration processing unit 210, receiving the ID-added document from the document operating unit 200, checks whether or not the document management server 10 is accessible (S3). If the document management server 10 is accessible, the registration processing unit 210 registers the ID-added document in the document management server 10 (S4), and otherwise, the registration processing unit 210 stores the ID-added document in the temporary storage unit 220 (S5).

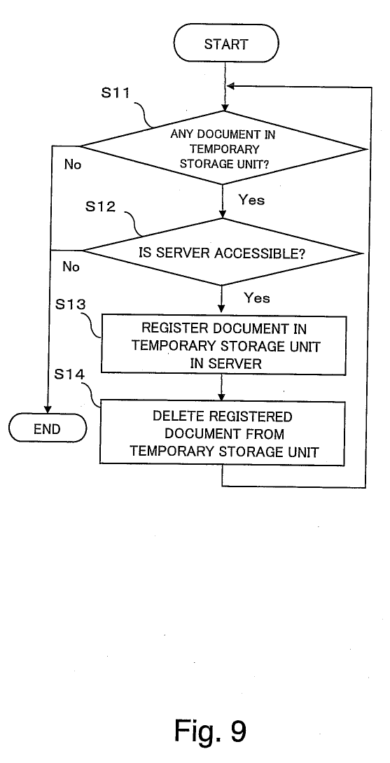

Referring now to FIG. 9, an example procedure of retry processing performed by the registration processing unit 210 will be described. This procedure is performed at a predetermined timing such as a timing when the registration processing unit 210 is actuated and a retry timing which would come periodically after the actuation of the registration processing unit 210.

When this procedure is actuated, the registration processing unit 210 checks whether or not an ID-added document exists in the temporary storage unit 220 (S11), and if no ID-added documents exists, terminates this procedure. On the other hand, if any ID-added document exists in the temporary storage unit 220, the registration processing unit 210 checks whether or not the document management server 10 is accessible (S12), and if accessible, extracts one ID-added document stored in the temporary storage unit 220 and registers the selected ID-added document in the document management server 10 (S13). The registration processing unit 210 further deletes the registered document from the temporary storage unit 220 (S14). If the document management server 10 is not accessible, this procedure is terminated. The above processing will be repeated until the temporary storage unit 220 becomes empty.

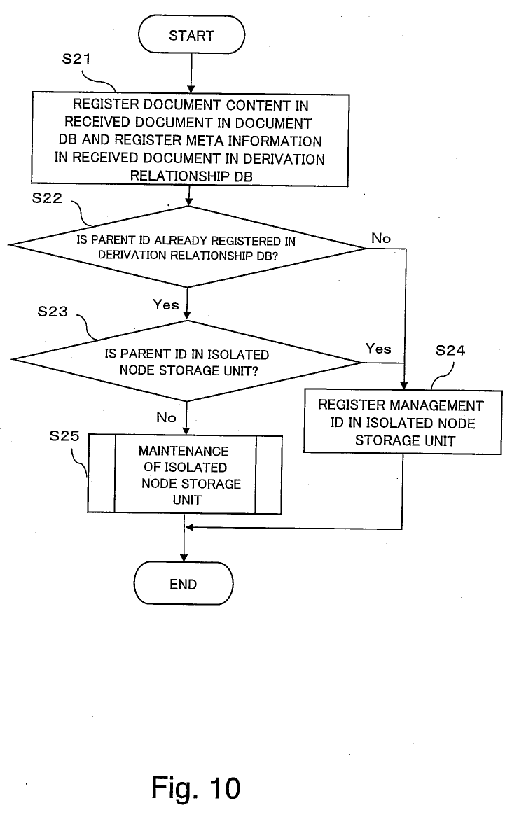

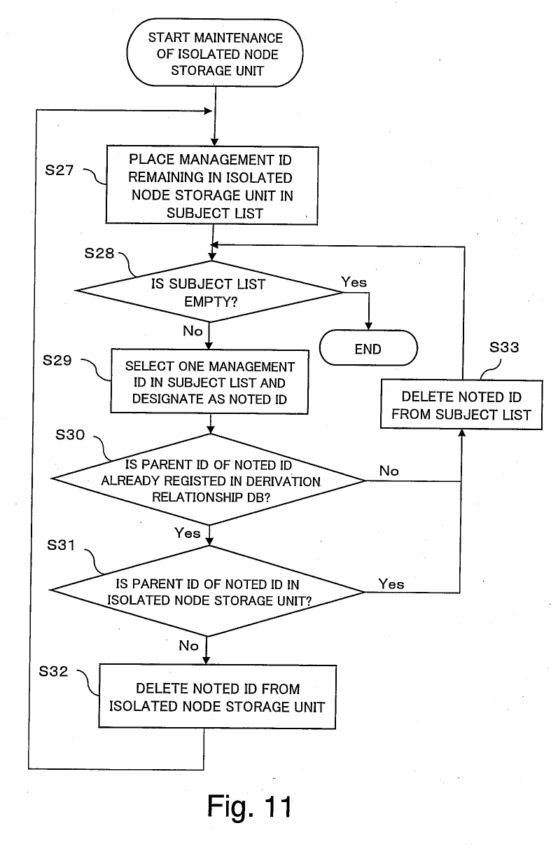

Referring now to FIGS. 10 and 11, an example of processing performed by the document registration unit 130 of the document management server 10 when receiving an ID-added document from the client terminal 20 will be described. According to this procedure, the document registration unit 130 first registers the document content of the received ID-added document in the document DB 100 and also registers the meta information in the received document in the derivation relationship DB 110 (S21). The document registration unit 130 (the derivation relationship registration unit 132) then determines whether or not the parent ID 314 in the ID-added document is “already registered” in the derivation relationship DB 110 (S22). Here, a parent ID 314 being “already registered” refers to the fact that a meta information record including the value of the parent ID as a management ID exists in the derivation relationship DB 110. Accordingly, in step S22, the derivation relationship registration unit 132 determines whether or not a meta information record including the management ID 110 which is the same value as the value of the parent ID 314 in the ID-added document exists in the derivation relationship DB. If such a meta information record exists, the parent ID is determined to be “already registered”.

If the parent ID is not “already registered”, the management ID of the ID-added document (i.e. a child of the parent ID) is registered in the isolated node DB 120 (S24). This situation occurs when the document management server 10 receives an ID-added document derived from an unknown document (i.e. a document which is not registered in the derivation relationship DB 110) from the client terminal 20. In this case, the document management server 10 can recognize that the received ID-added document has a parent, but does not ascertain ancestors preceding the parent because the parent is not registered in the derivation relationship DB 110. Such a management ID for which it is not possible to trace back the ancestors is referred to as an “isolated node” in a tree structure, in a sense that it is disconnected or isolated from the ancestors. When such an isolated node is detected, it is registered in the isolated node storage unit 120. In the example shown in FIGS. 5 to 7, when the document management server 10 receives the ID-added document “Doc3”, the determination result in step S22 is No (negative) and the management ID “Doc3” is registered in the isolated node storage unit 120.

The derivation relationship registration unit 132 also determines whether or not the parent ID is registered in the isolated node storage unit 120 (S23). If the parent ID is registered in the isolated node storage unit 120, meaning that the parent ID is an isolated node, naturally, it is not also possible to trace the ancestors with regard to the management ID, as with the parent ID. Accordingly, the derivation relationship registration unit 132 registers the management ID in the isolated node storage unit 120 (S24). In the example shown in FIGS. 5 to 7, the management IDs “Doc4” and “Doc5” correspond to this case. Here, either step S22 or S23 may be performed first.

When the parent ID included in the received ID-added document is already registered in the derivation relationship DB 110 and also is not registered in the isolated-node storage unit 120, it is possible to trace the tree of the derivation relationship from the management ID of the ID-added document and reach the root. However, this includes a case where an ID-added document which has not been notified by the client terminal 20 until then and has not been registered in the derivation relationship DB is received, that is a case where an ID-added document which has been stored in the temporary storage unit 220 of the client terminal 20 is transmitted to the document management server 10 by the retry processing performed by the registration processing unit 210. Specifically, this corresponds to a case where the ID-added document “Doc2” is registered in the document management server 10 in the example shown in FIGS. 5 and 7, for example. Such a case may allow any of the management IDs which have been stored in the isolated node storage unit 120 until now to trace the ancestors up to the initiator (root), due to the appearance of such a missing ID-added document described above. The management ID, for which tracing back to the initiator is thus allowed, is no longer isolated, and should be deleted from the isolated node storage unit 120. Accordingly, the derivation relationship registration unit 132 performs maintenance processing of the isolated node storage unit 120 (S25), an example procedure of which will be described with reference to FIG. 11.

Briefly summarized, according to the procedure shown in FIG. 11, with regard to each of the management IDs remaining in the isolated node storage unit 120, if a parent ID of the management ID is already registered in the derivation relationship DB 110 and also the parent ID is not included in the isolated node storage unit 120, the management ID is deleted from the isolated node storage unit 120. By recursively repeating this processing, all the management IDs connected to the ancestors due to reception of the ID-added document that is received in this time are deleted from the isolated node storage unit 120. Here, the procedure shown in FIG. 11 is described only for the purpose of illustration.

Stated more specifically, the derivation relationship registration unit 132 places all the management IDs remaining in the isolated node storage unit 120 in the subject list (S27). This subject list is used for confirming whether or not all the management IDs have been checked. The derivation relationship registration unit 132 then determines whether or not the subject list is empty (S28), and if the subject list is not empty, selects one management ID from the list and designates the selected management ID as a noted ID (S29). The derivation relationship registration unit 132 further determines whether or not a parent ID of the noted ID (which can be obtained from the derivation relationship DB 110) is already registered in the derivation relationship DB 110 (S30), and also whether or not the parent ID is included in the isolated node storage unit 120 (S31). If the determination result in step S30 is affirmative (Yes) and also the determination result in step S31 is negative (No), which means that the noted ID is now connected with the ancestors, then the derivation relationship registration unit 132 deletes the noted ID from the isolated node storage unit 120 (S32). In the example shown in FIG. 7, for example, if the ID-added document “Doc2” is registered in the document management server 10 and is consequently deleted from the isolated node storage unit 120, the determination result concerning the ID-added document “Doc3” is affirmative (Yes) in step S30 and the determination result is negative (No) in step S31, and therefore the document “Doc3” is also deleted from the isolated node storage unit 120 in step S32.

After step S32, the processing returns to step S27, where the subject list is updated in accordance with the deletion in step S32. More specifically, when it is found in step S32 that one new management ID is connected with its ancestors, there arises a possibility that any management IDs that were determined to be unconnected with their ancestors in the previous processing may now be determined to be connected with the ancestors. Accordingly, the subject list is updated by placing all the management IDs remaining in the isolated node storage unit 120 at this point in time in the subject list.

On the other hand, if the parent ID of a noted ID has not been registered in the derivation relationship DB 110 in step S30 or if the parent ID exists in the isolated node storage unit 120, this means that the noted ID is still unconnected with its ancestors. In this case, the registration relationship management unit 132 deletes the noted ID from the subject list (S33), and the processing returns to step S28. Then, if the subject list is determined to be empty in step S28, this means that no new management IDs should be further deleted from the isolated node storage unit 120 after thoroughly checking all the management IDs stored in the isolated node storage unit 120. Namely, all the management IDs connected to the ancestors have been deleted from the isolated node storage unit 120. Accordingly, this procedure is terminated.

The maintaining procedure for the isolated node storage unit 120 as shown in FIG. 11 is merely an example, and any procedure which allows all the management IDs that become connected with the ancestors in accordance with reception of an ID-added document from the client terminal 20 to be deleted from the isolated node storage unit 120 may be used. As an example, it is possible to determine, upon entering the maintenance processing in step S25, whether or not a child of the management ID of an ID-added document received in step S21 is registered in the derivation relationship DB 110 and, if the child is registered in the derivation relationship DB, obtain all the descendents after the child from the derivation relationship DB and delete them from the isolated node storage unit 120.

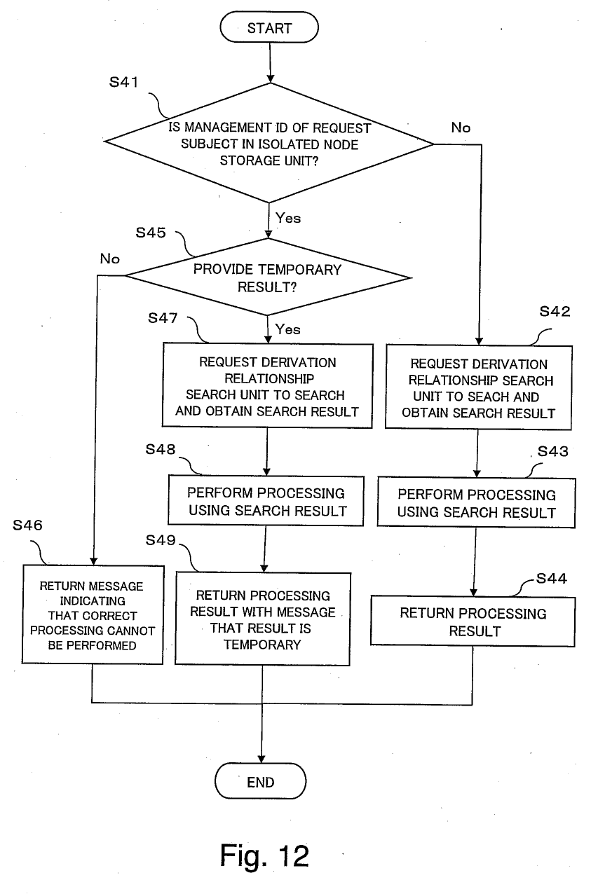

Referring now to FIG. 12, an example processing procedure of the request processing unit 140 will be described. This procedure is actuated when a service using the derivation relationship is requested from the client terminal 20.

Briefly summarized, in this procedure, whether or not it is possible to trace the tree of the derivation relationship from the management ID included in a service request from the client terminal 20 and reach its root is determined, and if it is not possible to trace back to the root, the fact that correct processing cannot be performed in response to the request is reported to the client terminal 20. In the example shown in FIGS. 5 and 7, it is assumed, for example, that the latest version (a version whose update time and date is the latest) of a document corresponding to the management ID “Doc4” is requested from the client terminal 20. In this case, while the latest version of the document should be “Doc 6” (“Content 4”), this latest version “Doc6” cannot be detected because the root “Doc1” cannot be reached from “Doc4” due to the absence of “Doc2”. If the latest version that can be reached from “Doc4” is to be searched in the state shown in FIG. 7, “Doc5” could be detected, which is not the actual latest version.

According to the procedure shown in FIG. 12, when receiving a service request from the client terminal 20, the request processing unit 140 determines whether or not the management ID included in this request exists within the isolated node storage unit 120 (S41). If the management ID does not exist in the isolated node storage unit 120, the root of the tree of the derivation relationship can be reached from the management ID. In this case, the request processing unit 140 requests the derivation relationship search unit 150 to perform a search of the derivation relationship from the management ID serving as a start point, and obtains the search result (S42). In response to this request, the derivation relationship search unit 150 traces the derivation relationship from the management ID back in the ancestor direction with reference to the derivation relationship DB 110. Then, when the root, which is a management ID whose parent ID value is empty (i.e. a management ID corresponding to the “registration” event) is reached, the derivation relationship is further traced from the root in its descendent direction. With this processing, the derivation relationship search unit 150 obtains the whole tree to which the management ID designated as a start point belongs, and returns information of each of the nodes (management IDs) belonging to the tree to the request processing unit 140 as a search result.

The request processing unit 140 then performs the service requested from the client terminal 20 based on the search result (S43), and returns the processing result to the client terminal 20 (S44). If the requested service is provision of the latest version of a document, the request processing unit 140 may search the management IDs included in the search result for one corresponding to the “update” operation whose operation time and date is the latest, and return an ID-added document including the document content corresponding to the searched management ID to the client terminal 20. Further, if the requested service is provision of history of a document corresponding to the management ID designated as a start point, the request processing unit 140 obtains a list of log information concerning each node (management ID) from the start point to the root of the corresponding tree based on the search result described above and return the result to the client terminal 20.

While in the above example the derivation relationship search unit 150 obtains a whole tree to which the management ID designated as a start point belongs, it is not always necessary to obtain the whole tree, depending on the search conditions. For example, when it is only necessary to grasp the root of a tree to which a management ID serving as a start point belongs, it is sufficient to specify and return the root as a search result.

If it is found, in step S41, that the management ID that is a subject of request exists in the isolated node storage unit 120, the request processing unit 140 then determines whether or not a temporary processing result is to be returned to the client terminal 20 (S45). Here, the temporary processing result refers to a processing result that can be obtained in the range of a subtree (which is not connected to the root) to which the management ID belongs. For this purpose, it is possible, for example, to previously provide, in the document management server 10, setting items for determining whether or not a temporary processing result is to be provided to the client terminal 20, and set these items by a managing person. In this case, the determination in step S45 is performed based on the values of these setting items. Further, whether or not the temporary processing result is necessary may be designated by a user who issued a request.

If provision of the temporary processing result is not necessary, the request processing unit 140 returns a message, indicating that there is a possibility that a correct processing result can not be obtained, to the client terminal 20 (S46), and terminates the processing without searching the derivation relationship DB 110. The client terminal 20 receives the message and then displays the message on the screen.

If the temporary processing result is to be provided, on other hand, the request processing unit 140 requests the derivation relationship search unit 150 to perform search using the management ID as a start point and obtains the search result (S47), performs the service requested using the client terminal 20 based on the search result (S48), and returns the processing result, along with message indicating that the result is a temporary processing result which is not necessarily correct, to the client terminal 20 (S49). The client terminal 20 then displays the processing result and the message on the screen. With the message, the user can know that the provided processing result may not be correct.

An exemplary embodiment has been described above. A modified example of the exemplary embodiment will now be described. In the exemplary embodiment described above, when an ID-added document 300 is registered in the document management server 10, it is determined whether or not the ID-added document is isolated from the root of the tree of the derivation relationship. In the modified example to be described below, on the contrary, such isolation determination is performed when the request processing unit 140 receives a service request from the client terminal 20. In this modified example, the isolated node storage unit 120 is not necessary.

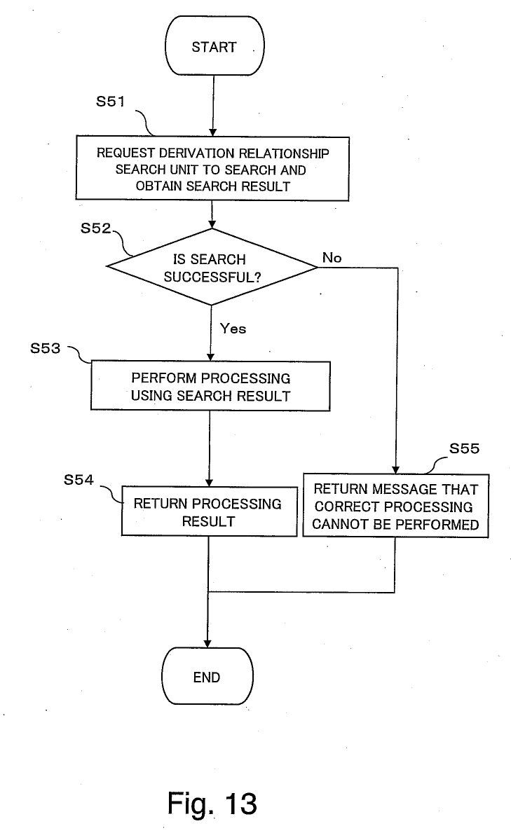

The procedure in this modified example will be described with reference to FIG. 13. According to this procedure, the request processing unit 140, receiving a service request from the client terminal 20, provides a management ID serving as a start point designated in the service request to the derivation relationship search unit 150 and requests for a search of the derivation relationship, and then obtains the search result (S51).

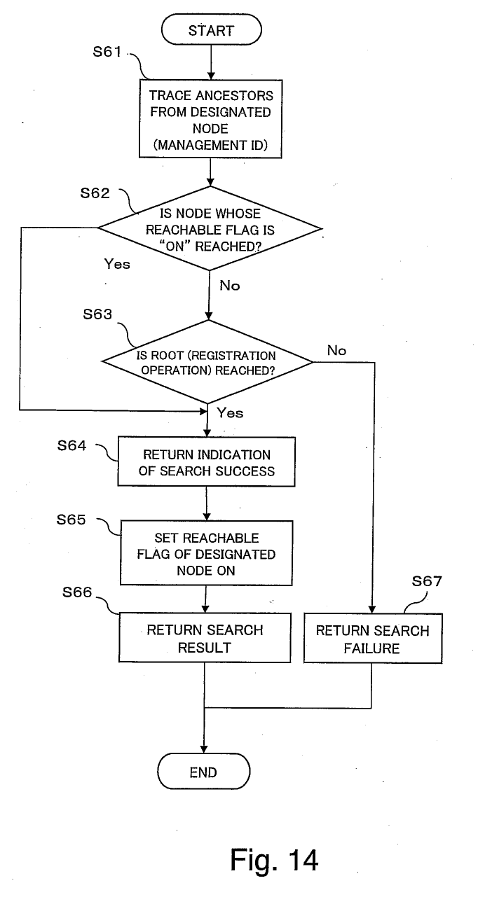

As shown in FIG. 14, the derivation relationship search unit 150 traces the derivation relationship in the derivation relationship DB 110 from the start point in the direction of its ancestors (S61), and when the root of the tree is reached, further traces the tree from the root in the direction of its descendents, thereby specifying nodes belonging to the tree. The derivation relationship search unit 150 then returns information of the specified nodes as a search result to the request processing unit 140. Here, the derivation relationship search unit 150 determines whether or not the root is reached in the course of the search (S63), and if the root is reached, returns the message indicating the success of search (S64) and further returns the search result (s66). If it is determined that the root has not been reached, on the other hand, the search is interrupted and the message indicating the failure of search is returned (S67). When it is determined, in the course of tracing the tree, that a parent of a node is not found, i.e. that a parent ID of the node has not been registered in the derivation relationship DB 110, it can be determined that the root cannot be reached.

Here, in the procedure shown in FIG. 14, a reachable flag is provided with regard to each management ID in the derivation relationship DB 110, so that whether or not a root is reachable can be determined before reaching the root. Specifically, once a root is determined to be reachable with respect to a certain management ID, a reachable flag of that management ID is set “ON” (S65) (the initial value is “OFF”), and when a node whose reachable flag is “ON” is reached in the course of tracing from the start point in the direction of the ancestors (S62), no further tracing is performed and the message indicating the success of search is returned (S64).

Referring back to FIG. 13, the request processing unit 140 determines whether or not the search result received from the derivation relationship search unit 150 is success (S52), and in the case of success of search, performs the requested processing using the received search result (S53) and returns the processing result to the client terminal 20 (S54). If the search result received from the derivation relationship search unit 150 is failure, the request processing unit 140 returns the message indicating that correct processing cannot be performed to the client terminal 20.

Here, although omitted in FIG. 13, even in the case of search failure (when the root cannot be reached), the request processing unit 140 may obtain a temporary processing result based on the information within the searchable range and return the temporary processing result with a message indicating that the result is “temporary” to the client terminal 20. In this case, the derivation relationship search unit 150 returns information concerning the subtree to which the start point belongs to the request processing unit 140, which then performs the processing in the range of the subtree. Further, even when the root cannot be reached, as long as the requested service can be achieved correctly within the range of the subtree, it is not necessary to return the message indicating “temporary”. For example, if a requested service is to provide “the latest version among the versions derived from the update version immediately before the start point”, a correct service can be achieved as long as a node of the “updated version immediately before” is included in the subtree.

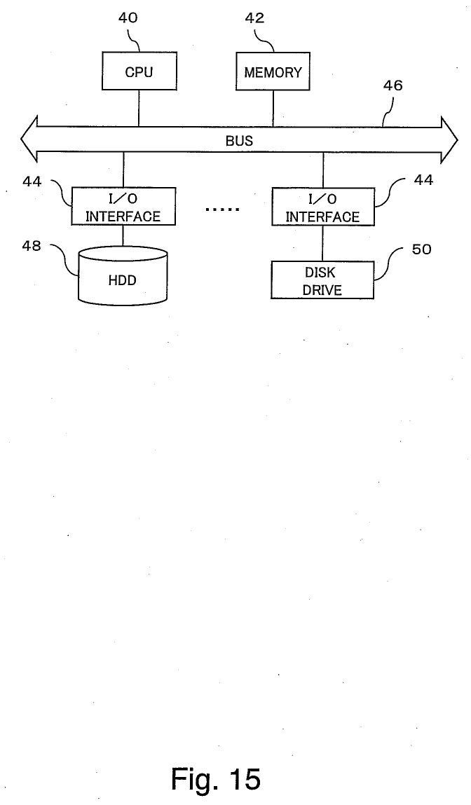

The document management server 10 in the illustrated system described above is typically implemented by executing a program that describes the function or processing contents of each unit of the document management server described above by a general-purpose computer. As shown in FIG. 15, the computer includes, as hardware, a circuit structure in which a CPU (central processing unit) 40, a memory (primary memory) 42, various I/O (input/output) interfaces 44, and so on are interconnected via a bus 46, for example. Further, a hard disk drive 48 and a disk drive 50 for reading a portable non-volatile recording medium of various standards such as CDs and DVDs and flash memories are connected, via the I/O interfaces 44, for example, to the bus 46. Such a drive 48 or 50 functions as an external storage device for the memory. The program that describes the processing contents of the exemplary embodiment is stored in a fixed storage device such as the hard disk drive 48 via a recording medium such as a CD or DVD or via the network, and then installed in the computer. When the program stored in the fixed storage device is read into the memory and performed by the CPU, the processing of the exemplary embodiment is implemented. Similarly, the client terminal 20 can be implemented by causing a general-purpose computer to perform a program that describes the document processing program described above. The foregoing description of the exemplary embodiments of the present invention has been provided for the purposes of the illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. A second information processing apparatus, comprising:
a receiving unit that receives from a first information processing apparatus a derivation relationship information item including identification information of a document prior to an operation as a parent and identification information after the operation as a child;
a derivation relationship storage unit that stores the derivation relationship information item that is received;
a first registration unit that, when receiving the derivation relationship information item from the first information processing apparatus, registers the child identification information included in the derivation relationship information item that is received in an isolated information storage unit, if no derivation relationship information items including, as a child, the parent identification information included in the derivation relationship information that is received are stored in the derivation relationship storage unit;
a second registration unit that, when receiving the derivation relationship information item from the first information processing apparatus, registers the child identification information included in the derivation relationship information item that is received in the isolated information storage unit, if the parent identification information included in the derivation relationship information item that is received is stored in the isolated information storage unit; and
a processing executing unit that, when receiving a processing instruction including identification information, traverses a tree structure of identification information represented by derivation relationship information items stored in the derivation relationship storage unit using the identification information included in the processing instruction as a start point and executes processing with regard to the processing instruction with reference to a result of the traversal, the processing executing unit transmitting a notification indicating that there is a possibility that a correct processing result is not obtained to a source that has issued the processing instruction, when the identification information included in the processing instruction is stored in the isolated information storage unit.

2. The second information processing apparatus according to claim 1, further comprising:
a deleting unit that, with regard to each identification information stored in the isolated information storage unit, when both a first condition that parent identification information of the identification information is stored in the derivation relationship storage unit, and a second condition that the parent identification information of the identification information is not registered in the isolated information storage unit, are satisfied, deletes child identification information in the corresponding derivation information from the isolated information storage unit.

3. A computer readable storage medium storing a program causing a computer to execute a process for providing a document search service, the process comprising:
receiving, from a first information processing apparatus, a derivation relationship information item including identification information of a document prior to an operation as a parent and identification information after the operation as a child and registering the derivation relationship information item in a derivation relationship storage unit;
when receiving the derivation relationship information item from the first information processing apparatus, registering the child identification information included in the derivation relationship information item that is received in an isolated information storage unit, if no derivation relationship information items including, as a child, the parent identification information included in the derivation relationship information that is received are stored in the derivation relationship storage unit;
when receiving the derivation relationship information item from the first information processing apparatus, registering the child identification information included in the derivation relationship information item that is received in the isolated information storage unit, if the parent identification information included in the derivation relationship information item that is received is stored in the isolated information storage unit; and
when receiving a processing instruction including identification information, traversing a tree structure of identification information represented by derivation relationship information items stored in the derivation relationship storage unit using the identification information included in the processing instruction as a start point and executing a processing with regard to the processing instruction with reference to a result of the traversal, in which, when the identification information included in the processing instruction is stored in the isolated information storage unit, a notification indicating that there is a possibility that a correct processing result is not obtained is transmitted to a source that has issued the processing instruction.

4. The storage medium according to claim 3, wherein the process further comprises:
with regard to each identification information stored in the isolated information storage unit, when both a first condition that parent identification information of the identification information is stored in the derivation relationship storage unit, and a second condition that the parent identification information of the identification information is not registered in the isolated information storage unit, are satisfied, deleting child identification information in the corresponding derivation information from the isolated information storage unit.

5. An information processing system, comprising a first information processing apparatus and a second information processing apparatus, the first information processing apparatus including:
a derivation relationship information generating unit that, when an operating unit performs an operation with regard to a document including first identification information, assigns second identification information to a document obtained after the operation and generates a derivation relationship information item indicating that the first identification information is a parent and the second identification information is a child; and
a transmitting unit that transmits the derivation relationship information item generated by the derivation relationship information generating unit, the transmitting unit storing the derivation relationship information item in a temporary storage unit when the derivation relationship information item cannot be transmitted to the second information processing apparatus, and transmitting the derivation relationship information item stored in the temporary storage unit to the second information processing apparatus when it becomes possible to transmit the derivation relationship information item to the second information processing apparatus, and
the second information processing apparatus including:
a derivation relationship storage unit that stores the derivation relationship information item that is received from the first information processing apparatus;
a first registration unit that, when receiving the derivation relationship information item from the first information processing apparatus, registers the child identification information included in the derivation relationship information item that is received in an isolated information storage unit, if no derivation relationship information item including, as a child, the parent identification information included in the derivation relationship information that is received are stored in the derivation relationship storage unit;
a second registration unit that, when receiving the derivation relationship information item from the first information processing apparatus, registers the child identification information included in the derivation relationship information item that is received in the isolated information storage unit, if the parent identification information included in the derivation relationship information item that is received is stored in the isolated information storage unit; and
a processing executing unit that, when receiving a processing instruction including identification information, traverses a tree structure of identification information represented by derivation relationship information items stored in the derivation relationship storage unit using the identification information included in the processing instruction as a start point, and executes processing with regard to the processing instruction with reference to a result of the traversal, to make the processing executing unit transmit a notification indicating that there is a possibility that a correct processing result is not obtained to a source that has issued the processing instruction when the identification information included in the processing instruction is stored in the isolated information storage unit.

6. The information processing system according to claim 5, wherein the second information processing apparatus further comprises:
a deleting unit that, with regard to each identification information stored in the isolated information storage unit, when both a first condition that parent identification information of the identification information is stored in the derivation relationship storage unit, and a second condition that the parent identification information of the identification information is not registered in the isolated information storage unit, are satisfied, deletes child identification information in the corresponding derivation information from the isolated information storage unit.

7. A second information processing apparatus, comprising:
a receiving unit that receives from a first information processing apparatus a derivation relationship information item including identification information of a document prior to an operation as a parent and identification information after the operation as a child;
a derivation relationship storage unit that stores the derivation relationship information item that is received; and
a processing executing unit that, when receiving a processing instruction including identification information, traverses a tree structure of identification information represented by derivation relationship information items stored in the derivation relationship storage unit using the identification information included in the processing instruction as a start point and executes processing, with regard to the processing instruction with reference to a result of the traversal, to make the executing unit transmit a notification indicating that there is a possibility that a correct processing result is not obtained to a source that has issued the processing instruction when it is not possible to reach a root by tracing the tree structure using the identification information included in the processing instruction as a start point in the direction of ancestors.

8. The second information processing apparatus according to claim 7, wherein the processing executing unit includes:
a recording unit that, when a root is reached by tracing the tree structure from the start point that is the identification information included in the processing instruction in the direction of ancestors, records that, with regard to the identification information, a root is reachable; and
an interrupting unit that, when identification information is reached with regard to which the recording units records a root as reachable in the course of tracing the tree structure from the start point that is the identification information included in the processing instruction in the direction of ancestors, interrupts the tracing processing.

9. A computer readable storage medium storing a program causing a computer to execute a process for providing a document search service, the process comprising:
receiving a derivation relationship information item including identification information of a document prior to an operation as a parent and identification information after the operation as a child from an information processing apparatus and registering the derivation relationship information item in a derivation relationship storage unit; and
when receiving a processing instruction including identification information, traversing a tree structure of identification information represented by derivation relationship information items stored in the derivation relationship storage unit using the identification information included in the processing instruction as a start point and executing processing with regard to the processing instruction with reference to a result of the traversal, in which, when it is not possible to reach a root by tracing the tree structure using the identification information included in the processing instruction as a start point in the direction of ancestors, a notification indicating that there is a possibility that a correct processing result is not obtained is transmitted to a source that has issued the processing instruction.

10. The storage medium according to claim 10, wherein the process further comprises:
when a root is reached by tracing the tree structure from the start point that is the identification information included in the processing instruction in the direction of ancestors, recording that, with regard to the identification information, a root is reachable; and
when identification information is reached with regard to the recording unit recording that a root is reachable in the course of tracing the tree structure from the start point that is the identification information included in the processing instruction in the direction of ancestors, interrupting the tracing processing.

11. An information processing system comprising:
a first information processing apparatus including:
a derivation relationship information generating unit that, when an operating unit performs an operation with regard to a document including first identification information, assigns second identification information to a document obtained after the operation and generates a derivation relationship information item indicating that the first identification information is a parent and the second identification information is a child; and
a transmitting unit that transmits the derivation relationship information item generated by the derivation relationship information generating unit, the transmitting unit storing the derivation relationship information item in a temporary storage unit when the derivation relationship information item cannot be transmitted to the second information processing apparatus, and transmitting the derivation relationship information item stored in the temporary storage unit to the second information processing apparatus when it becomes possible to transmit the derivation relationship information item to the second information processing apparatus, and
a second information processing apparatus including:
a derivation relationship storage unit that stores the derivation relationship information item that is received from the first information processing apparatus; and
a processing executing unit that, when receiving a processing instruction including identification information, traverses a tree structure of identification information represented by derivation relationship information items stored in the derivation relationship storage unit using the identification information included in the processing instruction as a start point, and executes processing with regard to the processing instruction with reference to a result of the traversal, to make the processing executing unit transmit a notification indicating that there is a possibility that a correct processing result is not obtained to a source that has issued the processing instruction when the identification information included in the processing instruction is stored in the isolated information storage unit.

12. The information processing system according to claim 11, wherein the processing executing unit includes:
a recording unit that, when a root is reached by tracing the tree structure from the start point that is the identification information included in the processing instruction in the direction of ancestors, records that, with regard to the identification information, a root is reachable; and
an interrupting unit that, when identification information is reached with regard to which the recording unit records that a root is reachable in the course of tracing the tree structure from the start point that is the identification information included in the processing instruction in the direction of ancestors, interrupts the tracing processing.
